(19) United States
(12) Patent Application Publication
(10) Pub. No.: US 2026/0062932 A1
(43) Pub. Date: Mar. 5, 2026

(54) TILT-UP WINDOW SYSTEMS AND RELATED DEVICES AND METHODS

(71) Applicant: Monarch Materials Group, Inc., Adel, IA (US)

(72) Inventor: David S. Mulcahy, Adel, IA (US)

(21) Appl. No.: 19/313,313

(22) Filed: Aug. 28, 2025

Related U.S. Application Data
(60) Provisional application No. 63/688,130, filed on Aug. 28, 2024.

(51) Int. Cl. E04G 15/02; E06B 1/36

(52) U.S. Cl. CPC E04G 15/02; E06B 1/36

(57) ABSTRACT

The technology disclosed herein relates to an improvement in windows cast directly into tilt-up concrete walls, which may then be tilted up with the windows in place. The improvements include the use of a single extrusion as a frame and sash, the ability to form chamfer(s) into the wall during casting, and the ability to integrate louvers.

### CROSS-REFERENCE TO RELATED APPLICATION(S)

This application claims priority to U.S. Provisional Patent Application No. 63/688,130, filed Aug. 28, 2024, and entitled “IMPROVED TILT-UP WINDOW SYSTEMS AND RELATED DEVICES AND METHODS,” the content of which is hereby incorporated by reference in its entirety under 35 U.S.C. § 119(e).

### TECHNICAL FIELD

The disclosure relates to construction generally, and the construction of tilt-up concrete walls with windows, specifically.

### BACKGROUND

As known to the precast wall industry, a method exists of installing a window in a precast wall involving positioning a window in the forms of the wall before the concrete of the wall is poured into the wall. Then the cast wall is tilted up into position with the window in place, having been captured by the concrete. Such a method is described in U.S. Pat. No. 11,834,823, which is hereby incorporated by reference in its entirety.

FIG. 1 shows a system of casting windows 10 into a tilt-up concrete wall 12. As would be understood, the windows 10 are placed on a flat, horizontal surface 14 that is sprayed with a release agent 16. The horizontal surface 14 also has forms for the concrete wall 12, which contain concrete surrounding the windows 10 until the concrete has solidified into the concrete wall 12. Then, the concrete wall 12, with windows 10 captured, can then be lifted off of the horizontal surface 14 and erected at a nearby construction site or shipped to a construction site remote from the casting site.

### BRIEF SUMMARY OF THE INVENTION

Disclosed herein are various implementations of a system for casting windows into concrete walls, such as but not limited to tilt-up walls, with various improvements over the prior art, along with associated methods and devices. As would be understood, the tilt-up walls may be cast on-site or precast in a separate location.

The various implementations discussed herein are directed to windows in tilt-up concrete walls or other concrete walls that have a frame made of a single extrusion, cause a chamfer(s) to be formed into the tilt-up concrete walls, contain louvers, and several other improvements, as will be discussed.

Example 1 is a window assembly comprising: a single extrusion frame configured to be cast directly into a tilt-up concrete wall; and a fixture configured to be secured into the single extrusion frame.

Example 2 relates to Examples 1 and 3-9, wherein the single extrusion frame comprises one or more spurs shaped to interlock with the tilt-up concrete wall.

Example 3 relates to Examples 1-2 and 4-9, wherein the single extrusion frame comprises an integrated sash shaped to grip the fixture.

Example 4 relates to Examples 1-3 and 5-9, further comprising a glazing bead positioned on the opposite side of the fixture from the integrated sash.

Example 5 relates to Examples 1-4 and 6-9, further comprising: an inner form comprising an edge, the inner form located on a first side of the single extrusion frame; and an outer form comprising a side, the outer form located on a second side of the single extrusion frame.

Example 6 relates to Examples 1-5 and 7-9, wherein the inner form comprises one or more overhangs shaped to create a chamfer in the tilt-up concrete wall, and wherein the outer form comprises one or more overhangs shaped to create a chamfer in the tilt-up concrete wall.

Example 7 relates to Examples 1-6 and 8-9, wherein the fixture is a pane.

Example 8 relates to Examples 1-7 and 9, wherein the fixture is a louver.

Example 9 relates to Examples 1-8, wherein the louver is adjustable.

Example 10 is a window assembly comprising: an outer frame configured to be cast directly into a tilt-up concrete wall; a sash base configured to couple to the outer frame; and a fixture configured to be secured into sash base.

Example 11 relates to Examples 10 and 12-17, wherein the outer frame and sash base couple using a locking mechanism.

Example 12 relates to Examples 10-11 and 13-17, wherein the sash base comprises an integrated sash shaped to grip the fixture.

Example 13 relates to Examples 10-12 and 14-17, further comprising a glazing bead positioned on the opposite side of the fixture from the integrated sash.

Example 14 relates to Examples 10-13 and 15-17, further comprising: an inner form comprising an edge, the inner form located on a first side of the sash base; and an outer form comprising a side, the inner form located on a second side of the sash base.

Example 15 relates to Examples 10-14 and 16-17, wherein the inner form comprises one or more overhangs shaped to create a chamfer in the tilt-up concrete wall, and wherein the outer form comprises one or more overhangs shaped to create a chamfer in the tilt-up concrete wall.

Example 16 relates to Examples 10-15 and 17, wherein the fixture is a louver configured to be secured into the sash base.

Example 17 relates to Examples 10-16, wherein the louver is adjustable.

Example 18 is a window assembly comprising: a single extrusion frame configured to be cast directly into a tilt-up concrete wall; and a fixture configured to be secured into the single extrusion frame; an inner form comprising an edge, the inner form located on a first side of the sash base; and an outer form comprising a side, the inner form located on a second side of the sash base, wherein the tilt-up concrete wall contains an insulation layer, wherein the inner form comprises one or more overhangs shaped to create a chamfer in the tilt-up concrete wall, and wherein the outer form comprises one or more overhangs shaped to create a chamfer in the tilt-up concrete wall.

Example 19 relates to Examples 18 and 20, further comprising a seam in the tilt-up concrete wall.

Example 20 relates to Examples 18 and 19, wherein one or more overhangs align with the seam to form a chamfer at the seam.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF DRAWINGS

FIG. 1 is an illustration of a tilt-up concrete wall as would be poured with windows integrated, according to one implementation.

FIG. 2 is a cross-sectional view of a single extrusion frame, according to one implementation.

FIG. 3 is a cross-sectional view of a single extrusion frame coupled to a fixture, according to one implementation.

FIG. 4 is a cross-sectional view of an outer frame and a sash base coupled to a fixture, according to one implementation.

FIG. 5 is a cross-sectional view of window assembly, according to one implementation.

FIG. 6 is a cross-sectional view of a window assembly in a tilt-up concrete wall with insulation, according to one implementation.

FIG. 7 is a cross-sectional view of a window assembly with several chamfers, according to one implementation.

FIG. 8 is an image of a window with an integrated louver, according to one implementation.

FIG. 9A is a cross-sectional view of a window assembly with an integrated louver, according to one implementation.

FIG. 9B is a cross-sectional view of a window assembly with an integrated louver with a chamfer, according to one implementation.

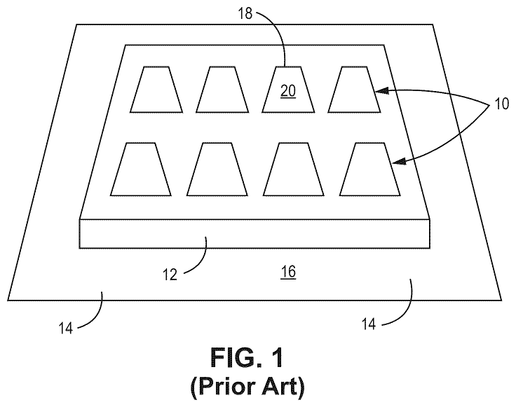

### DETAILED DESCRIPTION

The windows 10 used in this known system typically have a frame 18 that ends up embedded in the concrete wall 12. The frame 18 may be coupled to a fixture 20. In various implementations, the fixture 20 is a pane 20 of glass, stained glass, plexiglass, or similar material with a sash and/or glazing. As would be understood, the traditional frames 18 may be constructed of multiple pieces.

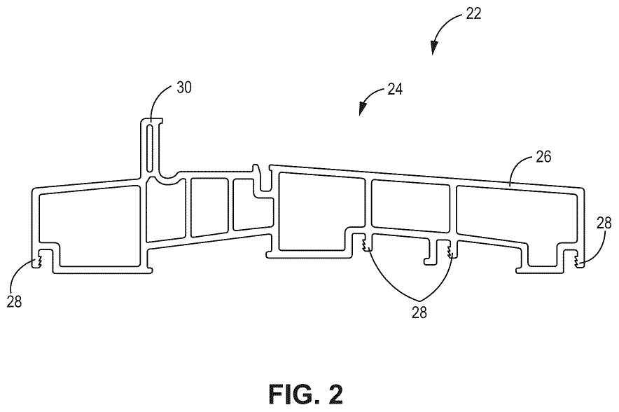

Turning to FIG. 2, various implementations of the presently disclosed system 22 use a single extrusion frame 24 (“SEF”). In various implementations, the SEF 24 consists of a main body 26 with several spurs 28 that capture wet concrete to secure the SEF 24 into the concrete wall 12, once dried and hardened. In various implementations, the SEF 24 may be designed to slope towards its outer portions so that rainwater and other moisture may run toward the outside of the window 10 once the window 10 is in position.

In some implementations, the SEF 24 also may have an integrated sash 30, which may be a protrusion extending from the main body 26.

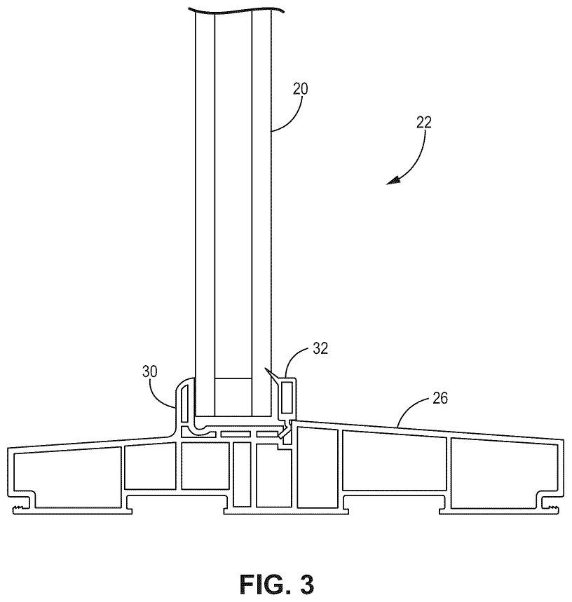

As shown in FIG. 3, in various implementations, the integrated sash 30 may be constructed and arranged to grip a fixture 20. In various implementations, the fixture 20 may be a window pane, a louver, door (including access doors, emergency exit doors, and other variations), fan, air conditioning unit, heating unit, heat pump, ducting, or similar structure that may be installed into a tilt-up concrete wall 12. In some implementations, the fixture 20 may be a single sheet of material, such as glass or plexiglass. In other implementations, the fixture 20 may be an insulated glass unit, which may be a multi-pane unit with insulating cavities separating the individual panes. In various implementations, the fixture 20 may be 1 inch thick or 1.25 inches thick, although other dimensions are possible. In some implementations, the window 10 may meet Miami-Dade County specifications. In other implementations, the window 10 may meet Howard County specifications. In various implementations, the window 10 may meet various other requirements and specifications known to the art.

In various implementations, the system 22 may use a glazing bead 32 to secure the fixture 20 against the integrated sash 30, as shown in FIG. 3. In various implementations, the glazing bead 32 may be removable. In some implementations, the glazing bead 32 may provide a watertight seal between the SEF 24 and the fixture 20. In various implementations, the glazing bead 32 may be capable of compensating for various thicknesses of fixtures 20.

In various implementations, the total distance from the concrete of the tilt-up concrete wall 12 over the SEF 24, and to the optionally glass portion of the fixture 20 may be about 2 inches, although other dimensions are possible.

In certain implementations, the SEF 24 may contain an internal metal stiffener to provide increased rigidity for harsh applications.

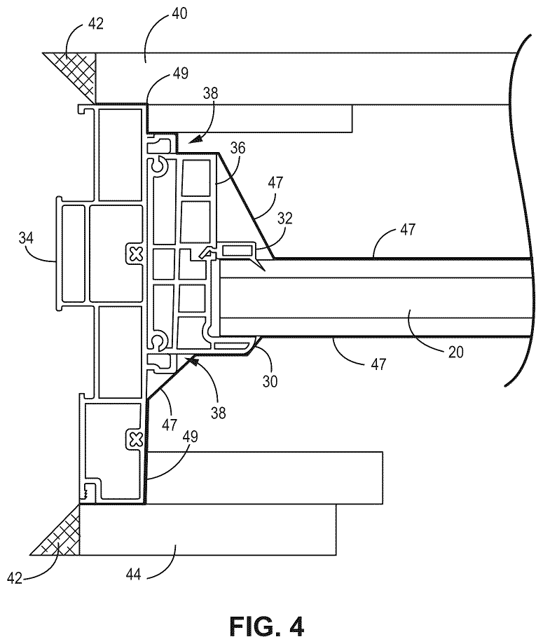

Shown in FIG. 4, various implementations of the system 22 may have an outer frame 34 that couples to a sash base 36, which is constructed and arranged to grip a fixture 20. Optionally, the sash base 36 and fixture 20 may also be sealed with a glazing bead 32. Also optionally, the sash base 36 may have an integrated sash 30, which may be a protrusion extending from the sash base 36. In various implementations, the outer frame 34 and sash base 36 may couple together using one or more locking mechanisms 38 constructed to hold the outer frame 34 and sash base 36 together while optionally being separable. In various implementations, the locking mechanisms 38 may be a tongue and groove arrangement, although various other securing methods known in the art would be possible.

In various implementations, the total distance from the concrete of the tilt-up concrete wall 12 over the outer frame 34 and sash base 36, and to the optionally glass portion of the fixture 20 may be about 2 inches, although other dimensions are possible.

In various implementations, the outer frame 34 and sash base 36 may be designed to slope towards its outer portions so that rainwater and other moisture may run toward the outside of the window 10 once the window 10 is in position.

In certain implementations, the outer frame 34 and sash base 36 may contain an internal metal stiffener to provide increased rigidity for harsh applications.

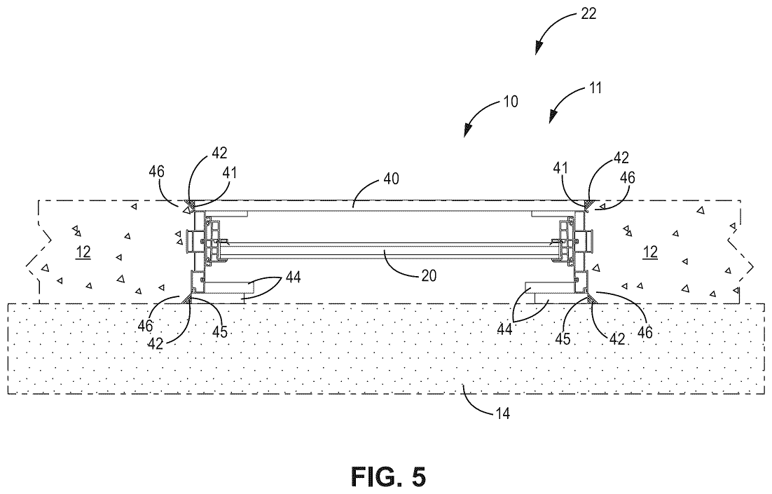

In some implementations, such as in FIGS. 4 and 5, the system 22 may include devices and methods involved in casting a window 10 into a tilt-up concrete wall 12. FIG. 5 shows a cut-away view of a window assembly 11, which may contain the window 10 as well as other components to be discussed, cast into a tilt-up concrete wall 12, according to such implementations. In various implementations, the window 10 may have an inner form 40 that may be a substantially flat sheet with a thickness significantly smaller than its other two dimensions. As would be understood, the sides of the inner form 40 with the thickness as one of its two-dimensional components may be called the edge 41, of which there are typically four for a square window 10, although other configurations are possible.

The inner form 40 may have one or more overhang 42. In some implementations, the overhang 42 or overhangs 42 may be projections that are substantially triangular in profile and extend from the edges 41 of the inner form 40. These overhangs may be positioned such that, when concrete is poured, they displace the concrete to form chamfers—angled transitions—at the interface between the window assembly and the concrete wall, as will be discussed in detail below.

In some implementations, the window assembly 11 may also have an outer form 44 that may be a substantially flat sheet with a thickness significantly smaller than its other two dimensions. As would be understood, the sides of the outer form 44 with the thickness as one of its two-dimensional components may be called the side 45, of which there are typically 4 for a square window 10, although other configurations are possible.

Similar to the inner form 40, the outer form 44 may also have an overhang 42 or overhangs on one or more of its sides 45.

In various implementations, the overhangs 42 on the inner form 40 and outer form 44 may be present prior to pouring concrete around the window assembly 11 in the process of casting the tilt-up concrete wall 12. As would be understood, the presence of the overhangs 42 during the casting of the tilt-up concrete wall 12 may result in the formation of chamfers 46 in the pre tilt-up cast concrete wall 12 by way of the overhangs 42 occupying the volume that would have otherwise formed sharp corners near the window assembly 11. More specifically, various implementations may have chamfers 46 present on the inside and outside facing portions of the tilt-up concrete wall 12. In various implementations, the chamfers may be at about a 45° angle to the surfaces of the tilt-up concrete wall 12, although other angles are possible. As would be understood, the chamfers 46 may provide several benefits over traditional squared-off edges. A non-exhaustive list of the benefits of the chamfers 46 include a reduced chance of damage to the chamfer 46 area due to the lack of sharp angles, a reduced risk of injury to employees if a body part were to impact the chamfer 46 area due to the lack of sharp angles, the elimination of a moisture pooling point between the frame 18/SEF 24/outer frame 34 and the tilt-up concrete wall 12 which could lead to concrete deterioration, and the improved aesthetics of a more gentle transition between the tilt-up concrete wall 12 and the window 10.

In various implementations, the chamfers 46 created by the overhangs 42 may be about ¾″ measured on their diagonal face. In other implementations, the chamfers 46 may be about ½″, about 1″, or about 1 and 1/16″. Of course, various other sizes of chamfers 46 are possible.

In various implementations, the fixture 20 may be covered with a film 47 to keep dust and debris from damaging the fixture 20 during transportation and installation. In some implementations, the film 47 may be secured to the window assembly 11 by way of tape 49 that may be secured to the outer frame 34 and/or sash base 36.

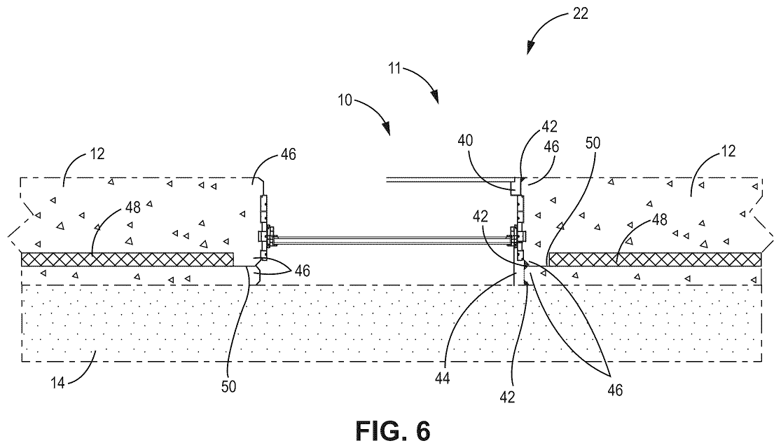

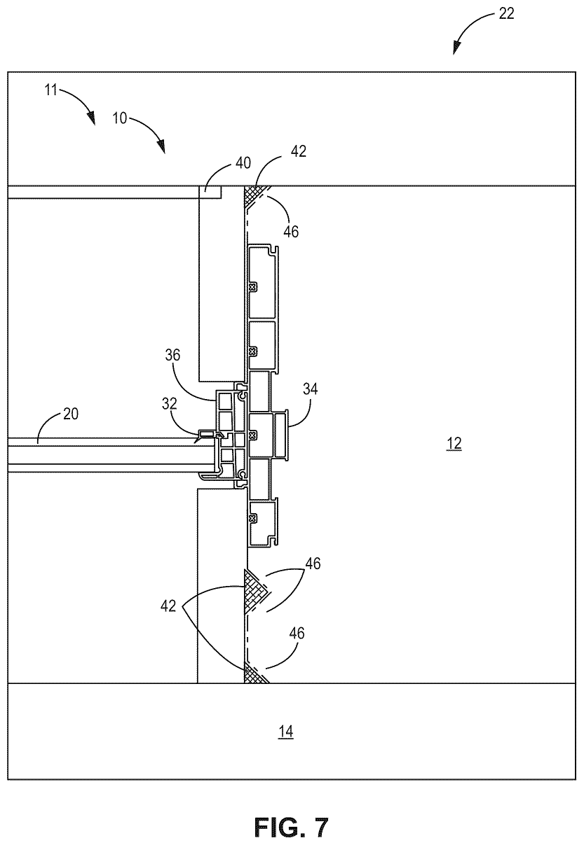

Turning now to FIG. 6, in various implementations, the tilt-up concrete wall 12 may have an embedded insulation layer 48. In some implementations, the insulation layer 48 may require a seam 50 to be present in the tilt-up concrete wall 12 due to the casting methods needed to embed the insulation layer 48. In other implementations, the presence of a seam 50 may be independent of the presence of an insulation layer 48. In various implementations, the inner form 40 and/or outer form 44 may have an overhang 42 that aligns with the seam 50 so as to form a chamfer 46 around the seam 50. Of course, chamfers 46 such as this could be formed anywhere along the inner form 40 and/or outer form 44 regardless of the location or presence of a seam 50. FIG. 7 shows one implementation of such a chamfer 46 where no seam 50 is present.

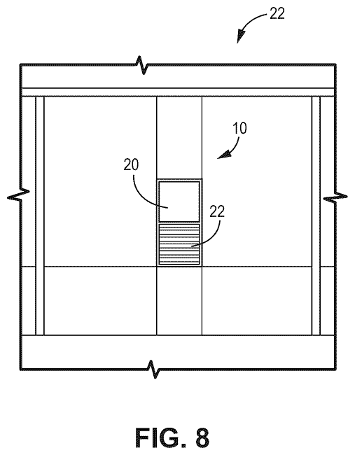

In various implementations, such as in FIG. 8, the window 10 may have a fixture 20 and a louver 52. As would be understood, a louver 52 may be a section made of angled slats that allows for ventilation while preventing ingress of water and debris. In various implementations, the slats of the louver 52 may be adjustable so that they can be opened to allow increased ventilation or shut to completely prevent ingress of material. In some implementations, the louvers 52 may be a plurality of slats each mounted on a pivot mechanism and spaced appropriately to allow the slats to overlap when pivoted to lay flat against one another.

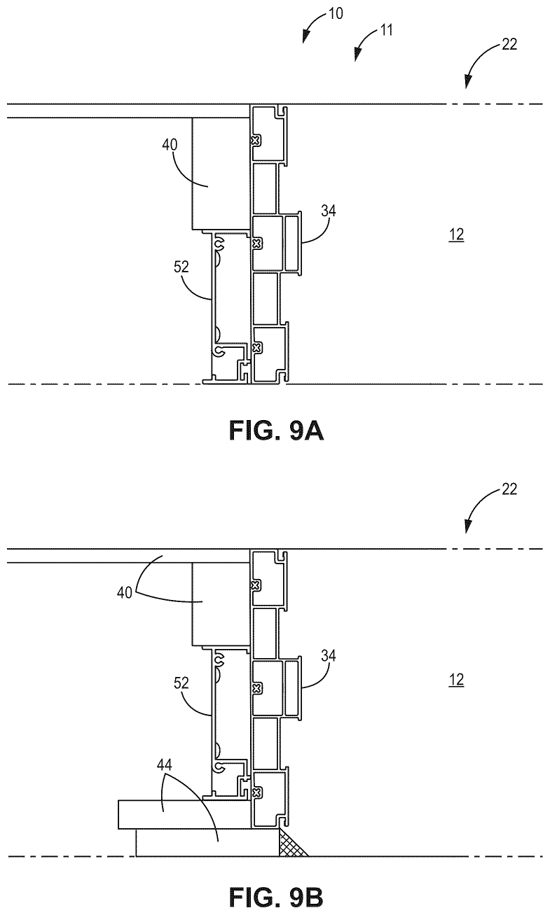

FIGS. 9A and 9B show various implementations of louvers 52 being integrated into the window assembly 11. In various implementations, the louvers 52 engage with the outer frame 34. In some implementations, the louvers 52 may be positioned relative to the outer frame 34 by varying the size of the inner form 40 and outer form 44. FIG. 9A shows one implementation where no outer form 44 is present, and as such, the louver 52 is about flush with the tilt-up concrete wall12. FIG. 9B shows another implementation where both an outer form 44 and inner form 40 are present, and as such, the louver 52 is recessed on both sides from the surfaces of the tilt-up concrete wall 12.

In various implementations, the window assembly 11 may have both a louver 52 and a pane 20. In other implementations, the window assembly 11 may have either a louver 52 or a pane 20.

Various implementations of the window assembly 11 may include mullions, also called muntins. In various implementations, the mullions may be present in the fixture 20 either running vertically, horizontally, or both.

In various implementations, two or more window assemblies 11 may be installed together, referred to as mulling in the art, to allow for larger window space without the need for a larger premanufactured or custom manufactured window assembly 11.

FIG. 10 shows a method of repairing a window 10 of the system 22.

In various implementations, the window 10 and window assembly 11 may have a drip edge running around the SEF 24 or outer frame 34.

Although the disclosure has been described with reference to preferred embodiments, persons skilled in the art will recognize that changes may be made in form and detail without departing from the spirit and scope of the disclosed apparatus, systems and methods.

What is claimed is:

1. A window assembly comprising:
(a) a single extrusion frame configured to be cast directly into a concrete wall; and
(b) a fixture configured to be secured into the single extrusion frame.

2. The window assembly of claim 1, wherein the single extrusion frame comprises one or more spurs shaped to interlock with the concrete wall.

3. The window assembly of claim 1, wherein the single extrusion frame comprises an integrated sash shaped to grip the fixture.

4. The window assembly of claim 3, further comprising a glazing bead positioned on the opposite side of the fixture from the integrated sash.

5. The window assembly of claim 1, further comprising:
(c) an inner form comprising an edge, the inner form located on a first side of the single extrusion frame; and
(d) an outer form comprising a side, the outer form located on a second side of the single extrusion frame.

6. The window assembly of claim 5, wherein the inner form comprises one or more overhangs shaped to create a chamfer in the concrete wall.

7. The window assembly of claim 5, wherein the outer form comprises one or more overhangs shaped to create a chamfer in the concrete wall.

8. The window assembly of claim 1, wherein the fixture is a pane.

9. The window assembly of claim 1, wherein the fixture is a louver.

10. A window assembly comprising:
(a) an outer frame configured to be cast directly into a concrete wall;
(b) a sash base configured to couple to the outer frame; and
(c) a fixture configured to be secured into sash base.

11. The window assembly of claim 10, wherein the outer frame and sash base couple using a locking mechanism.

12. The window assembly of claim 10, wherein the sash base comprises an integrated sash shaped to grip the fixture.

13. The window assembly of claim 12, further comprising a glazing bead positioned on the opposite side of the fixture from the integrated sash.

14. The window assembly of claim 10, further comprising:
(c) an inner form comprising an edge, the inner form located on a first side of the sash base; and
(d) an outer form comprising a side, the inner form located on a second side of the sash base.

15. The window assembly of claim 14, wherein the inner form comprises one or more overhangs shaped to create a chamfer in the concrete wall, and wherein the outer form comprises one or more overhangs shaped to create a chamfer in the concrete wall.

16. The window assembly of claim 10, wherein the fixture is a louver configured to be secured into the sash base.

17. The window assembly of claim 15, wherein the louver is adjustable.

18. A window assembly comprising:
(a) a single extrusion frame configured to be cast directly into a concrete wall; and
(b) a fixture configured to be secured into the single extrusion frame;
(c) an inner form comprising an edge, the inner form located on a first side of the sash base; and
(d) an outer form comprising a side, the inner form located on a second side of the sash base,
wherein the concrete wall contains an insulation layer,
wherein the inner form comprises one or more overhangs shaped to create a chamfer in the concrete wall, and
wherein the outer form comprises one or more overhangs shaped to create a chamfer in the concrete wall.

19. The window assembly of claim 18, further comprising a seam in the concrete wall.

20. The window assembly of claim 19, wherein one or more overhangs align with the seam to form a chamfer at the seam.
